(19) United States
(12) Patent Application Publication
(10) Pub. No.: US 2008/0261100 A1
(43) Pub. Date: Oct. 23, 2008

(54) Polymer electrolyte membrane and membrane electrode assembly

(76) Inventors: Atsuhiko ONUMA, Hitachi (JP); Makoto MORISHIMA, Hitachinaka (JP); Iwao FUKUCHI, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/081,807

(22) Filed: Apr. 22, 2008

(30) Foreign Application Priority Data
Apr. 23, 2007 (JP) 2007-112778

(51) Int. Cl. H01M 8/10; C08J 5/20

(52) U.S. Cl. 429/33; 521/27

(57) ABSTRACT

It is the objective to provide an electrolyte membrane with low cost, high ion conductivity, and low swelling.

It is comprised of a hydrophilic segment containing a sulfonic acid group and a hydrophobic segment where a sulfonic acid group is not contained, and it uses a polymer electrolyte for a fuel cell containing a block copolymer where the relationship between the glass-transition temperature of the hydrophobic segment (Tg1) and the glass-transition temperature of the hydrophilic segment (Tg2) is Tg1>Tg2.

### CLAIM OF PRIORITY

The present application claims priority from Japanese Application Serial No. 2007-112778, filed on Apr. 23, 2007, the content of which is hereby incorporated by reference into this application.

### FIELD OF THE INVENTION

The present invention relates to a polymer electrolyte membrane, a membrane electrode assembly, and a fuel cell using it, which is low cost and where the degree of swelling is low and the ion conductivity is improved.

### BACKGROUND OF THE INVENTION

FIG. 1 is across-sectional drawing illustrating a typical configuration of a membrane electrode assembly, in which 1 is a polymer electrolyte membrane, 2 is an anode, and 3 is a cathode. The present invention is applied to this membrane electrode assembly.

As a polymer electrolyte membrane for a fuel cell, a fluorine system electrolyte membrane having high ion conductivity is well known, such as Nafion (registered trademark and made by E.I du Pont de Nemours and Company), Aciplex (registered trademark and made by Asahi Kasei Corporation), and Flemion (registered trademark and made by Asahi Glass Corporation), etc. However, a fluorine system electrolyte membrane is very expensive. Moreover, fluorinated acid is created when it is burned during disposal. Moreover, since the ion conductivity decreases at a temperature higher than 100° C., there is the problem that it cannot be used above 100° C. Moreover, when it is used for an electrolyte membrane of a direct methanol type fuel cell (hereinafter, it is called a DMFC), there are the problems of voltage drop and generating efficiency drop, etc. due to methanol crossover.

As a polymer electrolyte membrane of a fuel cell, a non-fluorine polymer electrolyte is also used, such as an aromatic hydrocarbon system electrolyte membrane having an ion-exchange group, in addition to the fluorine system electrolyte.

Moreover, JP-A No. 2003-031232 and JP-A No. 2006-512428T disclose a block copolymer which has a polyether sulfone block containing a sulfonic acid group and a polyether sulfone block not containing a sulfonic acid group and a block copolymer which has a polyether ketone block containing a sulfonic acid group and a polyether ketone block not containing a sulfonic acid group. However, when a polyether sulfone block not containing a sulfonic acid group is used for a hydrophobic segment, there has been a problem where it becomes water-soluble and a decrease in the strength is caused during water absorption. Moreover, there has been a problem with large methanol permeation when an electrolyte membrane having large swelling is used for a DMFC.

On the other hand, when a polyether ketone block containing a sulfonic acid group is used for a hydrophilic segment, there has been a problem where it becomes water-soluble and a decrease in the strength is caused during water absorption.

JP-A No. 2003-031232 discloses as a polymer electrolyte membrane of a fuel cell that a block copolymer of a segment where an ion exchange group is introduced and a segment where an ion exchange group is not introduced in practice have excellent chemical stability such as film-making, oxidation resistance, radical resistance, and resistance to hydrolyzability, mechanical strength of a membrane, water resistance, and proton conductivity.

A copolymer described in JP-A No. 2004-190002 is different from a copolymer of the present invention in the respect that the hydrophobic part thereof has a higher glass-transition temperature than the hydrophilic part. Moreover, a polyimide is not concretely described in JP-A No. 2004-190002.

Therefore, it is an objective of the present invention to provide a polymer electrolyte membrane, a membrane electrode assembly, and a fuel cell using it which is low cost and where the degree of swelling is low and the ion conductivity is improved.

### SUMMARY OF THE INVENTION

According to the aforementioned situation, in a non-fluorine polymer electrolyte membrane, the inventors have developed an electrolyte membrane where the concentration of the sulfonic acid group in the electrolyte membrane can be increased because swelling of the electrolyte membrane is small and, at the same time, where the ion conductivity can be made higher.

In another viewpoint of this invention, it is an objective to provide a polymer electrolyte of a fuel cell comprising a block copolymer which has the hydrophilic segment and the hydrophobic segment where the relationship between the full width at half maximum β1 of the main peak in an X-ray diffraction of the hydrophobic segment and the full width at half maximum β2 of the main peak in an X-ray diffraction of the hydrophilic segment is β1>β2.

According to the present invention, a polymer electrolyte membrane which has high ion conductivity and low swelling characteristics can be obtained and the output of the fuel cell can be improved by using it.

### BRIEF DESCRIPTION OF THE DRAWINGS

FIG. 1 is a cross-sectional drawing illustrating a membrane electrode assembly of an embodiment of the present invention;

FIG. 2 is a cross-sectional drawing illustrating a configuration of a unit fuel cell in an embodiment of the present invention; and

FIG. 3 is an expanded prospective view illustrating a configuration of a fuel cell of the present invention.

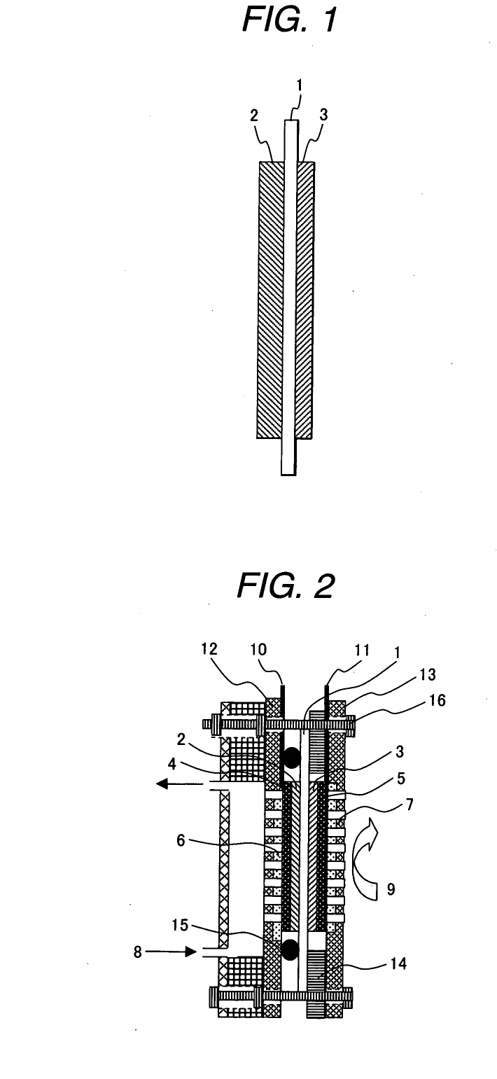

### DETAILED DESCRIPTION OF THE PREFERRED EMBODIMENT

The inventors have concentrated their energies on achieving the aforementioned objectives. As a result, a polymer electrolyte membrane which has high ion conductivity and low swelling characteristics can be obtained by using a block copolymer where the glass-transition temperature of the hydrophobic segment is higher than the glass-transition temperature of the hydrophilic segment or by using a block copolymer where the full width at half maximum of the main peak in an X-ray diffraction of the hydrophobic segment is smaller than the full width at half maximum of the main peak in an X-ray diffraction of the hydrophilic segment, resulting in the present invention being developed. Herein, a block copolymer means a copolymer containing at least one hydrophilic segment and at least one hydrophobic segment which are directly or indirectly covalently bonded to each other.

In a preferable mode, the hydrophobic segment and the hydrophilic segment are previously reacted independently to form the hydrophobic segment and the hydrophilic segment, and then a block copolymer is obtained by polymerization of these segments. A method for forming the block copolymer is not limited. For instance, a method may be applied where only one side of the hydrophobic part is made hydrophilic by using sulfuric acid and chlorosulfuric acid after a hydrophobic-hydrophobic block copolymer is synthesized.

As the reason for low swelling, it is considered that the intermolecular interaction of the hydrophobic segments is large. It is considered that the high ion conductivity thereof is achieved by keeping small the degrees of freedom of water in the hydrophilic segment, which has a small intermolecular interaction. Since it is a polymer electrolyte membrane having small swelling, the methanol permeation is small when it is used for a DMFC.

A polymer electrolyte used in the present invention is a copolymer which contains a hydrophilic segment and a hydrophobic segment as structural units. The hydrophilic segment has a structural unit which contains a relatively larger number of sulfonic acid groups and the hydrophobic segment has a structural unit which has a number of sulfonic acid groups smaller than the hydrophilic segment.

The hydrophilic segment having a large number of sulfonic acid groups in the main chain or the side chain can be shown as the following formula (1).

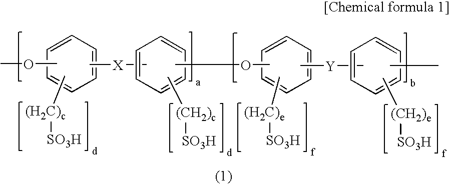

where, X and Y are any of

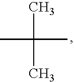

direct coupling,

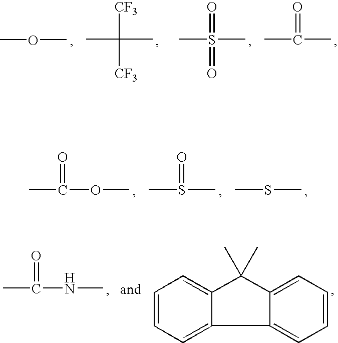

and they may be identical or different. a is 0 or an integer equal to or greater than 1, and b is an integer equal to or greater than 1. Moreover, 0≦c, d, e, f≦1. c, d, e, and f are 0 or 1 or more, at least one of c and e is not 0, and at least one of d and f is not 0.

Moreover, a hydrophobic segment where the number of sulfonic acid groups in the main chain and the side chain is smaller than that of the hydrophilic segment or where it is not substantially contained can be shown as the following formula (2) or formula (3).

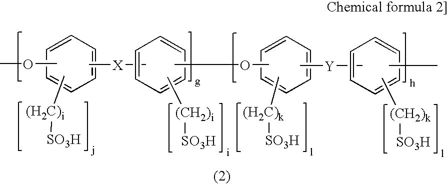

where, X and Y are any of

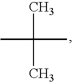

direct coupling,

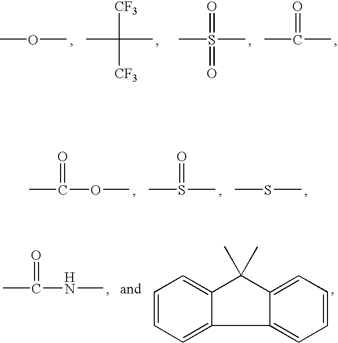

and they may be identical or different. g is 0 or an integer equal to or greater than 1, and h is an integer equal to or greater than 1. Moreover, (j+l)<(d+f) and 0≦i, j, k, l≦1. i, j, k, l is 0 or 1 or more, at least one of c and e is not 0, and at least one of d and f is not 0.

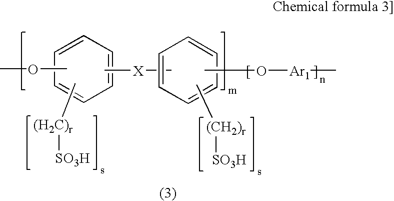

where, X is any of

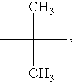

direct coupling,

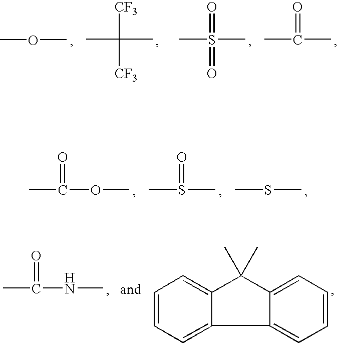

and it may be identical or different. m and n is 0 or an integer equal to or greater than 1; 0≦r, s≦1; and s<(d+f). In addition, Ar₁ is any of the following formulas (4) to (8) and a substituent may be introduced in the formulae (4) to (8).

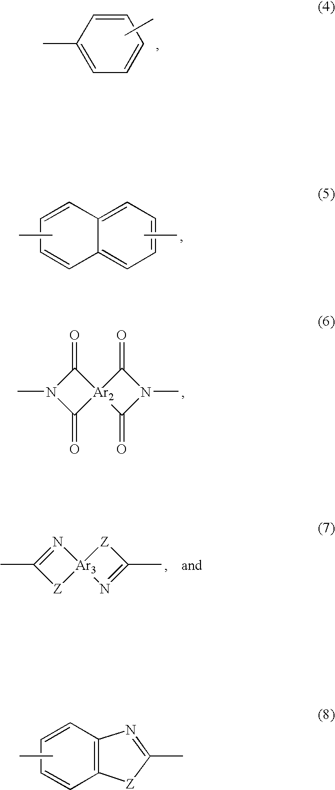

where, Ar₂ and Ar₃ are tetravalent groups having at least one aromatic ring. Z is —O—, —S—, and —NR— (herein, R means a hydrogen atom or an alkyl group having a carbon number of 1 to 6, an alkoxy group having a carbon number of 1 to 10, and an aryl group having a carbon number of 6 to 10, in which an alkyl group, alkoxy group, and an aryl group may be substituted), and the two Z may be identical or different.

The most preferable in formula (3) is where the Ar₂ is shown as formula (6). Therefore, a copolymer composed of a structural unit of a hydrophilic segment shown as formula (1) and a hydrophobic segment where Ar₁ in formula (3) is shown as formula (6) is specifically preferable for a polymer electrolyte of the present invention.

The preferable embodiment of the present invention will be described in detail as follows.

In the present invention, if the glass-transition temperature of the hydrophobic segment is higher than the glass-transition temperature of the hydrophilic segment in the block copolymer, it is in the range of the present invention.

The glass-transition temperature can be measured by using thermomechanical analysis (TMA), differential scanning calorimetry (DSC), dynamic mechanical analysis (DMA), etc.

Moreover, in the present invention, if the full width at half maximum of the main peak in an X-ray diffraction of the hydrophobic segment is larger than that of the hydrophilic segment, it is in the range of the present invention. Concrete examples of the hydrophobic segment and the hydrophilic segment will be explained later. Therein, X-ray diffraction means the case where the scanning angle is controlled to be from 15 to 80°.

There is an aromatic hydrocarbon polymer such as a polyimide copolymer, a polybenzimidazole copolymer, a polyquinoline copolymer, a polysulfone copolymer, a polyethersulfone copolymer, a polyether ether ketone copolymer, a polyether ketone copolymer, a polyphenylene sulfide copolymer, and a polyetherimide as a hydrophobic segment of the present invention.

Herein, the hydrophobic segment means a copolymer where the ion exchange group equivalent weight is 1200 g/mol or more. The ion exchange group equivalent weight of the present invention means the molecular weight of polymer per introduced ion exchange group unit equivalent and it means that the smaller the value the greater the degree of introduction of the ion exchange group. The ion exchange group equivalent weight can be measured by ¹H-NMR spectroscopy, elemental analysis, an acid-base titration as described in JP-B No. Heil (1989)-52866, and a non-hydroxy-base titration (standard solution is benzene methanol solution of potassium methoxide), etc.

There is a sulfonated aromatic hydrocarbon system electrolyte such as sulfonated polyether ether ketone, sulfonated polyethersulfone, sulfonated acrylonitrile-butadiene-styrene polymer, sulfonated polysulfide, sulfonated polyphenylene, etc. and an aromatic hydrocarbon electrolyte such as sulfoalkyl polyether ether ketone, sulfoalkyl polyethersulfone, sulfoalkyl polyether ether sulfone, sulfoalkyl polysulfone, sulfoalkyl polysulfide, sulfoalkyl polyphenylene, sulfoalkyl polyether ether sulfone, and sulfoalkyl ether polyphenylene, etc. as a hydrophilic segment of the present invention.

Herein, the hydrophilic segment means a copolymer where the ion exchange group equivalent weight is 200 to 1500 g/mol and the ion exchange group equivalent weight thereof is smaller than that of the hydrophobic segment.

The number-average molecular weight of the block copolymer which comprises the polymer electrolyte of the present invention is from 10,000 to 250,000 when the molecular weight is expressed as the number-average molecular weight of the polystyrene conversion by using a GPC method. It is preferably from 20,000 to 220,000 and, more preferably, from 25,000 to 200,000. When it is smaller than 10,000, the strength of the electrolyte membrane becomes lower and, if it becomes higher than 200,000, it is not preferable because the output performance becomes lower.

Moreover, the ion exchange group equivalent weight of the block copolymer of the present invention is from 200 to 2,000 and, preferably, from 350 to 1,500.

The polymer electrolyte membrane of the present invention is one which is deposited after the polymer electrolyte of the present invention is dissolved into a solvent, and the polymer electrolyte membrane may have reinforcement, anti-oxidant, a Pt catalyst supported by carbon, and a Pt—Ru catalyst supported by carbon.

Hereinafter, the present invention will be described in detail referring to the embodiments. However, it is to be understood that the invention is not intended to be limited to the specific embodiment.

### First Embodiment

(1) Manufacturing Polymer “a” (Hydrophobic Segment)

After the inside of a 300 ml 4-neck round bottom flask with a reflux condenser to which a mixer, a thermometer, and a calcium chloride tube are connected is exchanged with nitrogen, it is synthesized by using 0.150 mol of 4,4-difluoro benzophenone, 0.156 mol of 4,4-biphenol, 0.174 mol of potassium carbonate and, as solvents, 40 ml of toluene and 100 ml of dimethylsulfoxide (DMSO). After filtering the synthesized solution, polymer “a” is obtained by re-precipitation using methanol. The solution in which the polymer “a” was dissolved in DMSO was film coated over a glass plate and dried in vacuum at 80° C., and it was dipped in water and dried, resulting in a 45 μm thick polymer membrane “a” being formed. The glass-transition temperature of the polymer membrane “a” was measured by using DMA, and the X-ray diffraction was also examined.

(2) Manufacturing Polymer “b” (Hydrophilic Segment)

After the inside of a 300 ml 4-neck round bottom flask with a reflux condenser to which a mixer, a thermometer, and a calcium chloride tube are connected is exchanged with nitrogen, 0.150 mol of sulfonated 4,4-difluoro diphenylsulfone, 0.156 mol of 4,4-biphenol, 0.174 mol of potassium carbonate, and 40 ml of toluene as an entrainer were added and synthesized at 170° C. for 10 hours by using 100 ml of dimethylacetamide as a solvent. After filtering the synthesized solution, polymer “b” was obtained by re-precipitation using methanol.

The solution in which the polymer “b” is dissolved into dimethylacetamide is film coated over a glass plate and dried in vacuum at 80° C., and it is dipped in water and dried, resulting in a 45 μm thick polymer membrane “b” being formed. The glass-transition temperature of the polymer membrane “b” was measured by using DMA, and the X-ray diffraction was also examined. As a result, the glass-transition temperature of the polymer membrane “b” is lower than the glass-transition temperature of the polymer membrane “a” and, with respect to the full width at half maximum of the main peak, the full width at half maximum of the polymer membrane “b” is larger than the full width at half maximum of the polymer membrane “a”.

### (3) Manufacturing Block Copolymer 1

After the inside of a 300 ml 4-neck round bottom flask with a reflux condenser to which a mixer, a thermometer, and a calcium chloride tube are connected is exchanged with nitrogen, the solution containing the polymer “a” synthesized in (1), the solution containing the polymer “b” synthesized in (2), sulfonated 4,4-difluoro phenylsulfone, potassium carbonate, and 40 ml of toluene as an entrainer were added and synthesized at 170° C. for 10 hours by using 100 ml of DMSO as a solvent. After filtering the synthesized solution, a block copolymer 1 was obtained by re-precipitation using methanol.

The compounding ratio of the polymer “a”, the polymer b”, and sulfonated 4,4-difluoro diphenylsulfone was controlled to have an ion exchange group equivalent weight of 600 g/mol. The number-average molecular weight Mn of the obtained block copolymer was equal to or greater than 4×10⁴, and the ion exchange group equivalent weight measured by a NMR is 620 g/mol. It is called block copolymer 1.

The structural formula of the obtained block copolymer 1 is the chemical formula (4).

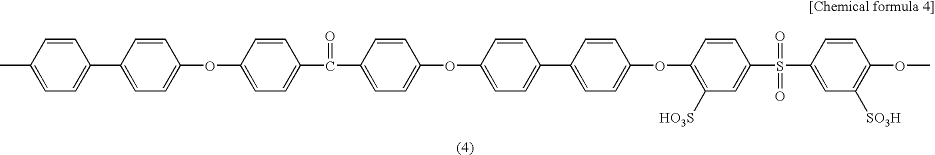

### (4) Manufacturing Polymer Electrolyte Membrane 1 and the Characteristics Thereof.

The block copolymer 1 obtained in the aforementioned (3) was dissolved into DMSO to have a concentration of 20 wt. %. The solution is film coated over a glass plate and dried in vacuum at 80° C., and it is dipped in sulfuric acid and water and dried, resulting in a 45 μm thick polymer electrolyte membrane 1 being obtained. The ion conductivity of this polymer electrolyte membrane 1 is 0.13 S/cm at 40° C. in water. Moreover, after soaking it in water at 80° C. for 24 hours, the area change was measured from the dry condition of the polymer electrolyte membrane and it was found out that the area increased by about 16%. The dry condition in this description means the condition where it is dried at 120° C. for 2 hours.

### (5) Manufacturing Membrane Electrode Assembly (MEA) 1

By preparing a slurry of a catalyst powder with an alloy fine powder of platinum/ruthenium having an atomic ratio of platinum and ruthenium of 1/1 where it is dispersed and supported to be 50 wt. % over a carbon carrier, 30 wt. % of polyperfluorosulfonic acid, and a mixed solvent of 1-propanol, 2-propanol, and methoxyethanol, an anode with a thickness of about 125 μm, a width of 30 mm, and a length of 30 mm was manufactured over a polyimide film by using a screen printing method.

Next, a slurry with a water/alcohol mixed solvent was prepared in which a catalyst powder where 30 wt. % of platinum fine particles were supported over the carbon carrier was mixed with polyperfluorosulfonic acid and a mixed solvent of 1-propanol, 2-propanol, and methoxyethanol used as binder, and a cathode with a thickness of about 20 μm, a width of 30 mm, and a length of 30 mm was manufactured over the polyimide film by using a screen printing method.

Both sides of the polymer electrolyte membrane 1 manufactured in the aforementioned (4) was sandwiched by the anode and the cathode and hot-pressed at 100° C. and 10 MPa, resulting in the membrane electrode assembly (MEA) 1 being formed where the anode and cathodes were formed on both sides of the polymer electrolyte membrane 1. The anode and the cathode were aligned to overlap each other and assembled.

An aqueous dispersion (Dispersion D-1: made by Daikin Kogyo Co., Ltd.) of fine particles of the repellent polytetrafluoroethylene (PTFE) was added to the carbon powder to be 40 wt. % by weight after baking and mixed to become a paste; this was coated over one surface of an approximately 350 μM thick carbon cloth with a porosity of 87%, dried at room temperature, and fired at 270° C. for 3 hours, resulting in a carbon sheet being formed. The amount of PTFE is controlled to be 5 to 20 wt. % relative to the carbon cloth. The obtained sheet was cut to be the shape, which has the same size as the electrode of the aforementioned MEA and used as the cathode diffusion layer. The approximately 350 μm thick carbon cloth with a porosity of 87% was dipped into fuming sulfuric acid (concentration of 60%) and kept under nitrogen gas flow for two days at 60° C. Next, the temperature of the flask was cooled down to room temperature.

The fuming sulfuric acid was removed and the carbon cloth washed until the distilled water became neutral. Next, it was soaked in methanol and dried. Absorption based on the —OSO₃H group was observed at 1225 cm⁻¹ and 1413 cm⁻¹ in the infrared spectroscopy absorption spectra of the obtained carbon cloth. Moreover, absorption based on the —OH group was observed at 1049 cm⁻¹. Accordingly, the —OSO₃H group and the —OH group are introduced over the surface of the carbon cloth and make it hydrophilic because the contact angle thereof becomes smaller than the contact angle of 81° between a methanol solution and a carbon cloth which is not treated by fuming sulfuric acid. Moreover, it had excellent conductivity. It was cut to be the shape which has the same size as the electrode of the aforementioned MEA 1 and used as the anode diffusion layer.

### (6) Power Generation Performance of a Direct Methanol Fuel Cell (DMFC)

The battery performance was measured by using the single cell of the polymer electrolyte fuel cell generator shown in FIG. 2 and assembling the aforementioned MEA1 with the aforementioned diffusion layer. In FIG. 2, 1 is a polymer electrolyte membrane, 2 is an anode, 3 is a cathode, 4 is an anode diffusion layer, 5 is a cathode diffusion layer, 6 is an anode current collector, 7 is a cathode current collector, 8 is fuel, 9 is air, 10 is an anode terminal, 11 is a cathode terminal, 12 is an anode end plate, 13 is a cathode end plate, 14 is a gasket, 15 is an O-ring, and 16 is a bolt/nut. 5 wt. % of a methanol water solution was circulated to the anode as the fuel and air was supplied to the cathode. It is continuously operated at 30° C. by applying a load of 50 mA/cm². An output of 0.30V or more was obtained from any DMFC using the MEA1 after 500 hours of operation and it is very stable. The DMFC using the MEA1 is assumed to be that of embodiment 1.

### Second Embodiment

(1) Manufacturing Polymer “c” (Hydrophobic Segment)

3, 3′,4,4′-biphenyl tetracarboxylic acid dehydrate (0.15 mol) (hereinafter it is called s-BPDA) and diaminodiphenyl ether (0.156 mol) (hereinafter, it is called DDE) are added in a 100 ml 4-neck round bottom flask with a reflux condenser under nitrogen purge, stirred for 10 hours at room temperature by using N-methyl-2-pyrolidone as a solvent, and reacted each other, resulting in a solution containing the polymer “c” being manufactured. After filtering, this solution was film coated over a glass plate and dried at 120° C., dipped in water and dried to prepare a 45 μm thick polymer membrane “c”. The glass-transition temperature of the polymer membrane “c” was measured by using DMA, and the X-ray diffraction was also examined.

(2) Polymerization of Polymer “d” (Hydrophilic Segment)

After the inside of a 300 ml 4-neck round bottom flask with a reflux condenser to which a mixer, a thermometer, and a calcium chloride tube are connected is exchanged with nitrogen, 0.15 mol of sulfonated 4,4-difluoro diphenylsulfone, 0.15 mol of 4,4-biphenol, 0.012 mmol of p-aminophenol, 0.174 mol of potassium carbonate, and 40 ml of toluene as an entrainer were added and synthesized at 180° C. by using 100 ml of NMP as a solvent. After filtering the synthesized solution, polymer “d” was obtained by re-precipitation using methanol. The solution in which the polymer “d” was dissolved into dimethylacetamide was film coated over a glass plate and dried in vacuum at 80° C., and it was dipped in water and dried, resulting in a 45 μm thick polymer membrane “d” being formed. The glass-transition temperature of the polymer membrane “d” was measured by using DMA, and the X-ray diffraction was also examined. As a result, the glass-transition temperature of the polymer membrane “d” is lower than the glass-transition temperature of the polymer membrane “c” and, with respect to the full width at half maximum of the main peak, the full width at half maximum of the polymer membrane “d” is larger than the full width at half maximum of the polymer membrane “C”.

### (3) Manufacturing Block Copolymer 2

After the inside of a 300 ml 4-neck round bottom flask with a reflux condenser to which a mixer, a thermometer, and a calcium chloride tube are connected is exchanged with nitrogen, the solution containing the polymer “c” synthesized in (1) of second embodiment and the solution containing the polymer “d” synthesized in (2) of second embodiment were added and synthesized at room temperature by stirring. The compounding ratio of the polymer “c” and the polymer d” was controlled to have an ion exchange group equivalent weight of 600 g/mol. The number-average molecular weight Mn of the obtained block copolymer was equal to or greater than 4×10⁴, and the ion exchange group equivalent weight measured by an NMR is 640 g/mol.

The structural formula of the obtained block copolymer is the chemical formula (5).

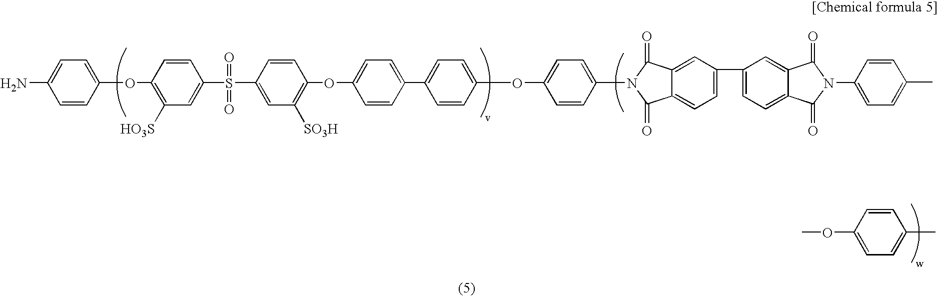

### (4) Manufacturing Polymer Electrolyte Membrane 2 and the Characteristics Thereof.

After the solution containing the block copolymer 2, which was obtained in (3) of the aforementioned second embodiment was filtered, was film coated over a glass plate, dried at 80° C. in vacuum, dried by heating at 200° C., and made into an imide, it was dipped in water and dried to prepare a 45 μm thick polymer film. The ion conductivity of this polymer electrolyte membrane 2 is 0.12 S/cm at 40° C. in water. Moreover, after this polymer electrolyte membrane was soaked in 80° C. water for 24 hours, the area change of the polymer electrolyte membrane from the dry condition was measured. As a result, a change in area of about 15% was observed.

### (5) Manufacturing the Membrane Electrode Assembly (MEA)

Except for the polymer electrolyte membrane described in (5) of the aforementioned first embodiment being substituted by the polymer electrolyte membrane described in (3) of the aforementioned second embodiment, the MEA 2 was manufactured by using the same conditions.

### (6) Power Generation Performance of a Direct Methanol Fuel Cell (DMFC)

Except for the MEA1 described in (6) of the aforementioned first embodiment being substituted by the MEA2 described in (4) of the aforementioned second embodiment, both of the DMFC which generated power under the same conditions generate an output of 0.33 V or more after 500 hours of operation and are stable.

### First Comparative Example

### (1) Polymerization of Polymer “e” (Hydrophobic Segment)

After the inside of a 300 ml 4-neck round bottom flask with a reflux condenser to which a mixer, a thermometer, and a calcium chloride tube are connected is exchanged with nitrogen, 0.150 mol of 4,4-difluoro diphenylsulfone, 0.156 mol of 4,4-biphenol, 0.174 mol of potassium carbonate, and 40 ml of toluene as an entrainer were added and synthesized at 170° C. for 10 hours by using 100 ml of NMP as a solvent. The polymer “e” was obtained by re-precipitation of the synthesized solution using methanol. The number-average molecular weight Mn of the polymer “e” was 2×10⁴ or more. The solution in which the polymer “e” was dissolved into NMP was film coated over a glass plate and dried at 80° C. in vacuum, dipped in water, and dried to prepare a 45 μm thick polymer membrane “e”. The glass-transition temperature of the polymer membrane “e” was measured by using DMA, and the X-ray diffraction was also examined. As a result, no significant differences existed between the polymer membrane “e” and the polymer membrane “b” in both the glass-transition temperature and the full width at half maximum of the main peak of the X-ray diffraction.

### (2) Manufacturing Block Copolymer 3

After the inside of a 300 ml 4-neck round bottom flask with a reflux condenser to which a mixer, a thermometer, and a calcium chloride tube are connected is exchanged with nitrogen, the solution containing the polymer “e” synthesized in (1) of the aforementioned first comparative example, the solution containing the polymer “b” synthesized in (2) of the aforementioned tenth comparative example, sulfonated 4,4-difluoro diphenylsulfone, potassium carbonate, and 40 ml of toluene as an entrainer were added and synthesized at 170° C. for 10 hours by using 100 ml of dimethylacetamide as a solvent. After filtering the synthesized solution, the block copolymer 3 was obtained by re-precipitation using methanol. The compounding ratio of the polymer “e”, the polymer “b”, and the sulfonated 4,4-difluoro diphenylsulfone was controlled to have an ion exchange group equivalent weight of 600 g/mol. The number-average molecular weight Mn of the obtained block copolymer is equal to or greater than 4×10⁴, and the ion exchange group equivalent weight measured by NMR is 610 g/mol.

### (3) Manufacturing the Polymer Electrolyte Membrane and the Characteristics Thereof

The block copolymer 3 obtained in (2) of the aforementioned fifth comparative example was dissolved into dimethylacetamide to have a concentration of 10 wt. %. The solution was film coated over a glass plate, dried in air, and dried in vacuum at 80° C. Then it was dipped in sulfuric acid and water and dried, resulting in a 45 μm thick polymer film being fabricated to become the polymer electrolyte membrane 3. The ion conductivity of this polymer electrolyte membrane is 0.14 S/cm at room temperature. Moreover, after this polymer electrolyte membrane was soaked in 80° C. water for 24 hours, the area change of the polymer electrolyte membrane from the dry condition was measured. As a result, an increase in area of about 38% was observed and this value means that the swelling thereof was very large compared with the first and second embodiments.

### (4) Manufacturing the Membrane Electrode Assembly (MEA)

Except for the electrolyte and the electrolyte membrane described in (5) of the aforementioned tenth embodiment being substituted by those manufactured in (3) of the first comparative example, the MEA 3 was manufactured by using the same conditions.

### (5) Power Generation Performance of a Direct Methanol Fuel Cell (DMFC)

The DMFC using the MEA manufactured in (4) of the aforementioned first comparative example generates an output of 0.32 V or less after 500 hours of operation and the output of the MEA 3 was not stable due to the effects of flooding.

### Third Embodiment

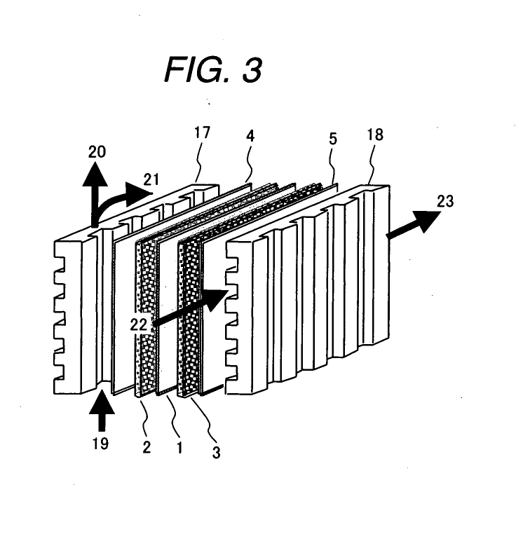

Using a small cell which employs hydrogen as a fuel which is shown in FIG. 3, the cell performance was measured by assembling a MEA4 with a diffusion layer which is manufactured by using an electrolyte membrane made in embodiment 1. In FIG. 4, 1 is a polymer electrolyte membrane; 2 is an anode; 3 is a cathode; 4 is an anode diffusion layer; 5 is a cathode diffusion layer; 17 is a fuel path of a conductive separator (bipolar plate) which has both the function of chamber separation and the function of a path for supplying the gas to the electrode; 18 is an air path of a conductive separator (bipolar plate) which has both the function of chamber separation and the function of a path for supplying the gas to the electrode; 19 is hydrogen and water which are fuel; 20 is hydrogen; 21 is water; 22 is air; and 23 is air and water. The small cell was set in a thermostatic oven and the temperature of the thermostatic oven was controlled so that the temperature measured by the thermo-couple inserted into the separator (not shown in the figure) was 70° C. An external humidifier was used for humidifying the anode and cathode and the temperature of the humidifier was controlled to be from 70 to 73° C. so that the dew point in the vicinity of the outlet of the humidifier was 70° C. By measuring the consumption of water for humidification all the time, in addition to measuring the dew point by using a dew-point instrument, it is confirmed that the dew point obtained by the flow rate of the reaction gas, the temperature, and the pressure is a predetermined value. The load current density was controlled to be 250 mA/cm², the hydrogen utilization factor to be 70%, and the air utilization factor to be 40%, thereby power was generated for about 8 hours/day and the rest was operated to keep the cell hot. Even after 3000 hours passed, it had an output of 80% or more of the initial voltage, so that it was understood that the membrane electrode assembly of the present invention has excellent durability when hydrogen was used for the fuel.

What is claimed is:

1. A polymer electrolyte comprising a block copolymer which has a hydrophilic segment containing a sulfonic acid group in the main chain or the side chain and a hydrophobic segment where a sulfonic acid group is not contained in the main chain and the side chain or the number of the sulfonic acid group is smaller than the number of the sulfonic acid group of the hydrophilic segment,
wherein the relationship between the glass-transition temperature of said hydrophobic segment (Tg1) and the glass-transition temperature of said hydrophilic segment (Tg2) is Tg1>Tg2.

2. The polymer electrolyte according to claim 1, wherein said hydrophilic segment is water-soluble.

3. The polymer electrolyte according to claim 1, wherein said hydrophilic segment is composed of a structural unit shown in the following chemical formula (1): 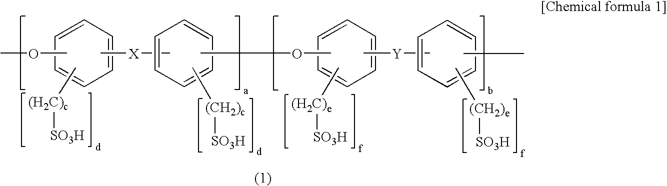
where, X and Y are any of 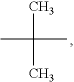
direct coupling, 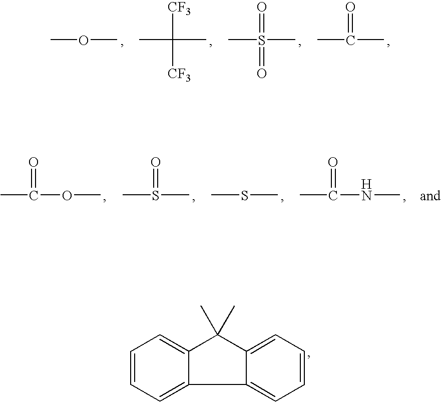
and they may be identical or different;
a is 0 or an integer equal to or greater than 1, and b is an integer equal to or greater than 1;
moreover, 0≦c, d, e, f≦1; and
c, d, e, and f are 0 or 1 or more, at least one of c and e is not 0, and at least one of d and f is not 0.

4. The polymer electrolyte according to claim 1, wherein said hydrophobic segment is composed of a structural unit illustrating the following chemical formula (2) or (3): 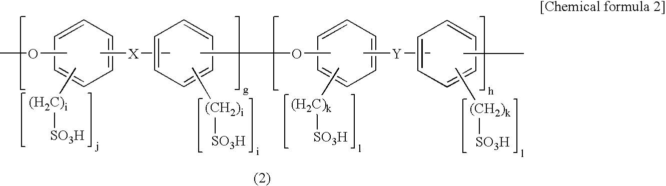
where, X and Y are any of 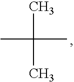
direct coupling, 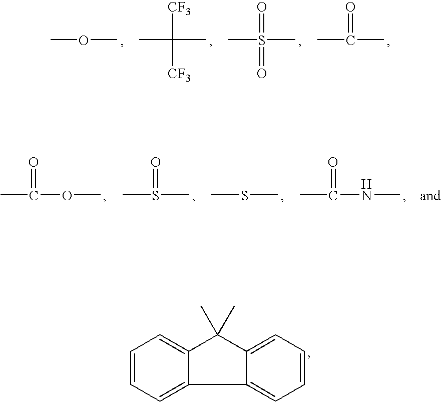
and they may be identical or different,
g is 0 or an integer equal to or greater than 1, and h is an integer equal to or greater than 1,
moreover, (j+l)<(d+f) and 0≦i, j, k, l≦1, and i, j, k, l is 0 or 1 or more, at least one of c and e is not 0, and at least one of d and f is not 0; and 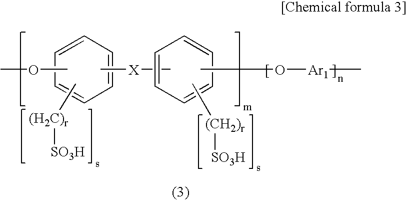
where, X is any of 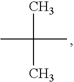
direct coupling, 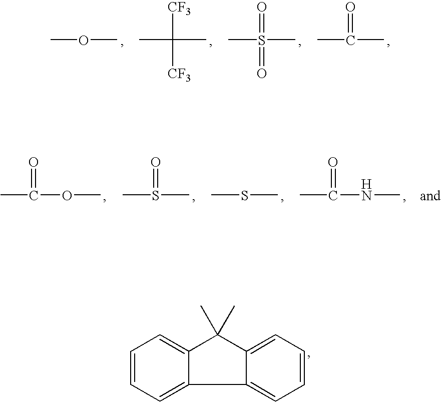
and it may be identical or different, and
m and n are 0 or an integer equal to or greater than 1, and 0≦r, s≦1, and moreover, s<(d+f),
in addition, Ar₁ is any of the following (4) to (8) and a substituent may be introduced in the formulae (4) to (8): 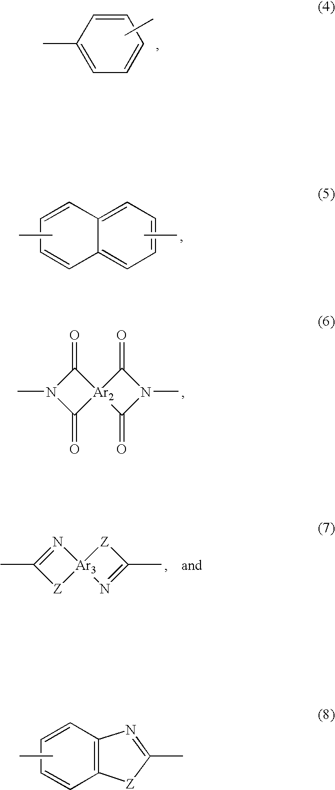
where, Ar₂ and Ar₃ are tetravalent groups having at least one aromatic ring; and
Z is —O—, —S—, and —NR— (herein, R means a hydrogen atom or an alkyl group having a carbon number of 1 to 6, an alkoxy group having a carbon number of 1 to 10, and an aryl group having a carbon number of 6 to 10, in which an alkyl group, an alkoxy group, and an aryl group may be substituted), and the two Z may be identical or different.

5. The polymer electrolyte according to claim 4, wherein Ar₁ in said chemical formula (3) is said chemical formula (6).

6. A polymer electrolyte according to claim 4, wherein Ar₁ of said hydrophobic segment shown in said chemical formula (3) is said chemical formula (6) and has a structural unit shown in the chemical formula (2).

7. A polymer electrolyte membrane comprising a deposited polymer electrolyte according to claim 1.

8. A membrane electrode assembly, comprising
an electrolyte membrane, a cathode electrode and an anode electrode sandwiching said polymer electrolyte membrane,
wherein said cathode electrode and anode electrode have at least one selected from carbon, an electrode catalyst supported by said carbon, and a polymer electrolyte,
wherein said polymer electrolyte membrane is the polymer electrolyte membrane according to claim 7.

9. A fuel cell comprising the membrane electrode assembly according to claim 8.

10. A polymer electrolyte comprising a block copolymer which has a hydrophilic segment containing a sulfonic acid group in the main chain or the side chain and a hydrophobic segment where a sulfonic acid group is not contained in the main chain and the side chain or the number of the sulfonic acid group is smaller than the number of the sulfonic acid group of the hydrophilic segment,
wherein the relationship between the full width at half maximum β1 of the main peak in an X-ray diffraction of said hydrophobic segment and the full width at half maximum β2 of the main peak in an X-ray diffraction of said hydrophilic segment is β1>β2.

11. The polymer electrolyte according to claim 10, wherein said hydrophilic segment is water-soluble.

12. The polymer electrolyte according to claim 10, wherein said hydrophilic segment is composed of a structural unit shown in the following chemical formula (1): 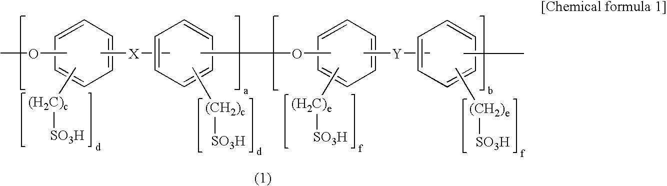
where, X and Y are any of 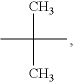
direct coupling, 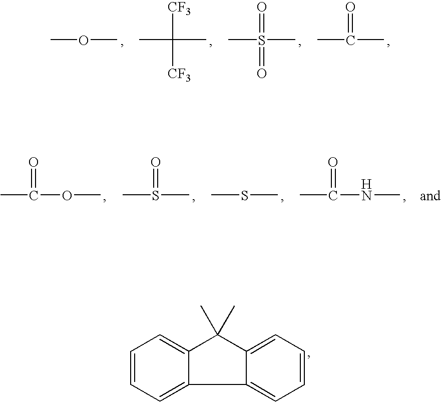
and they may be identical or different;
a is 0 or an integer equal to or greater than 1, and b is an integer equal to or greater than 1;
moreover 0≦sc, d, e, f≦1; and
c, d, e, and f are 0 or 1 or more, at least one of c and e is not 0, and at least one of d and f is not 0.

13. The polymer electrolyte according to claim 10, wherein said hydrophobic segment is composed of a structural unit illustrating the following chemical formula (2) or (3): 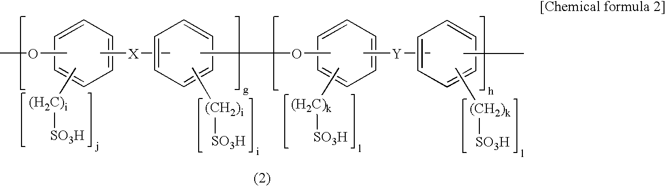
where, X and Y are any of 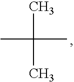
direct coupling, 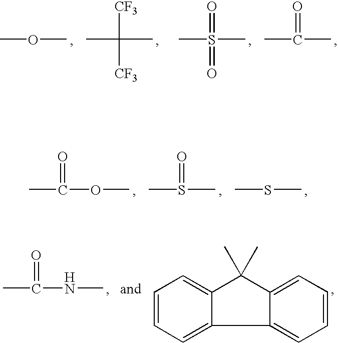
and they may be identical or different,
g is 0 or an integer equal to or greater than 1, and h is an integer equal to or greater than 1,
moreover, (j+l)<(d+f) and 0≦i, j, k, l≦1, and
i, j, k, l is 0 or 1 or more, at least one of c and e is not 0, and at least one of d and f is not 0; and 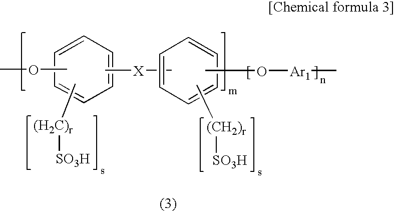
where, X is any of 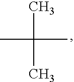
direct coupling, 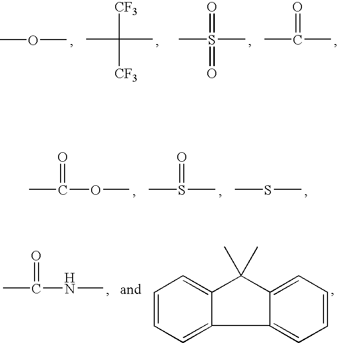
and it may be identical or different, and
m and n are 0 or an integer equal to or greater than 1, and 0≦r, s≦1, and moreover, s<(d+f),
in addition, Ar₁ is any of the following (4) to (8) and a substituent may be introduced in the formulae (4) to (8): 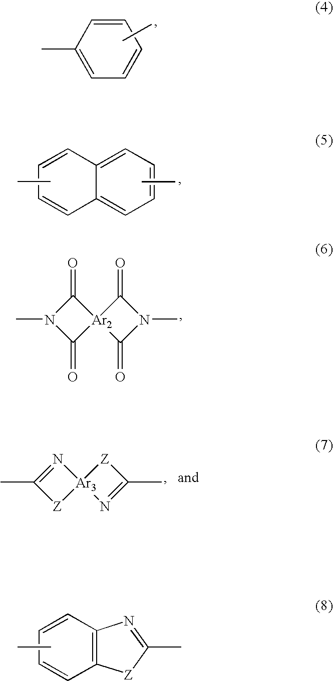
where, Ar₂ and Ar₃ are tetravalent groups having at least one aromatic ring; and
Z is —O—, —S—, and —NR— (herein, R means a hydrogen atom or an alkyl group having a carbon number of 1 to 6, an alkoxy group having a carbon number of 1 to 10, and an aryl group having a carbon number of 6 to 10, in which an alkyl group, an alkoxy group, and an aryl group may be substituted), and the two Z may be identical or different.

14. The polymer electrolyte according to claim 13, wherein Ar₁ in said chemical formula (3) is said chemical formula (6).

15. The polymer electrolyte according to claim 13, wherein Ar₁ of said hydrophobic segment shown in said chemical formula (3) is said chemical formula (6) and has a structural unit shown in the chemical formula (2).

16. A polymer electrolyte membrane comprising a deposited polymer electrolyte according to claim 10.

17. A membrane electrode assembly, comprising an electrolyte membrane, a cathode electrode and an anode electrode sandwiching said polymer electrolyte membrane,
wherein said cathode electrode and anode electrode have at least one selected from carbon, an electrode catalyst supported by said carbon, and a polymer electrolyte,
wherein said polymer electrolyte membrane is the polymer electrolyte membrane according to claim 16.

18. A fuel cell comprising the membrane electrode assembly according to claim 17.

19. A polymer electrolyte comprising a block copolymer which has a hydrophilic segment shown in the following chemical formula (1) and contains a sulfonic acid group in the main chain or the side chain, and a hydrophobic segment shown in the following chemical formula (2) or (3) in which a sulfonic acid group is not contained in the main chain and the side chain or the number of the sulfonic acid group is smaller than the number of the sulfonic acid group of the hydrophilic segment: 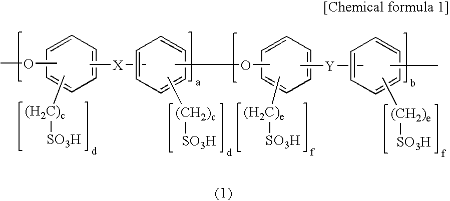
where, X and Y are any of 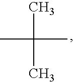
direct coupling, 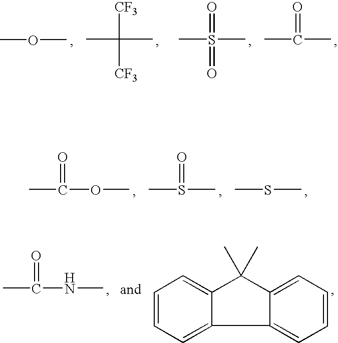
and they may be identical or different,
a is 0 or an integer equal to or greater than 1, and b is an integer equal to or greater than 1,
moreover, 0≦c, d, e, f≦1, and
c, d, e, and f are 0 or 1 or more, at least one of c and e is not 0, and at least one of d and f is not 0; 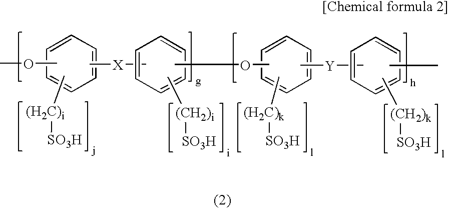
where, X and Y are any of 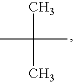
direct coupling, 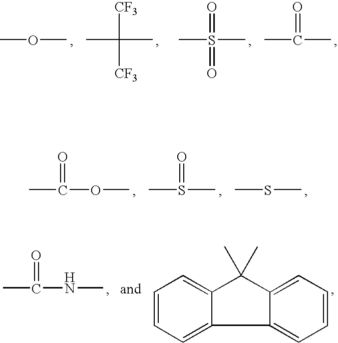
and they may be identical or different,
g is 0 or an integer equal to or greater than 1 and h is an integer equal to or greater than 1, and moreover, (j+l)<(d+f), g≦i, j, k, l≦1, and
i, j, k, and l are 0 or 1 or more, at least one of c and e is not 0, and at least one of d and f is not 0; and
[Chemical formula 3] 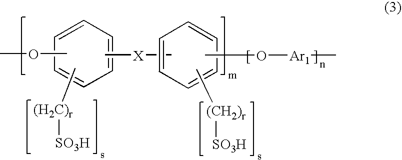
where, X is any of 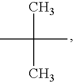
direct coupling, 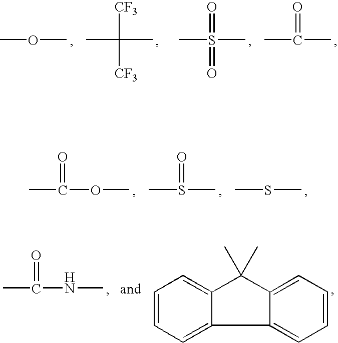
and it may be identical or different,
m and n is 0 or an integer equal to or greater than 1, and 0≦r, s≦1, and s<(d+f),
moreover, Ar₁ is any of the following (4) to (8) and a substituent may be introduced in the formula (4) to (8): 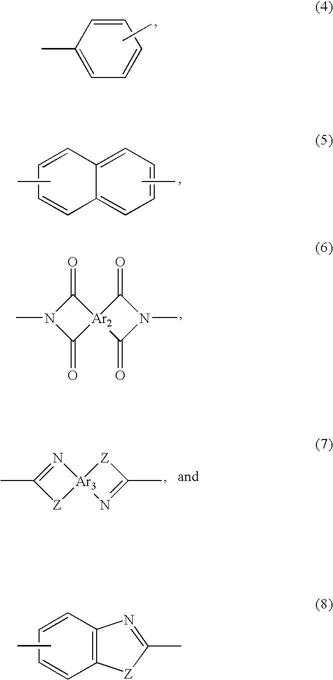
where, Ar₂ and Ar₃ are tetravalent groups having at least one aromatic ring, and
Z is —O—, —S—, and —NR— (herein, R means a hydrogen atom or an alkyl group having a carbon number of 1 to 6, an alkoxy group having a carbon number of 1 to 10, and an aryl group having a carbon number of 6 to 10, in which an alkyl group, an alkoxy group, and an aryl group may be substituted), and the two Z may be identical or different.

20. The polymer electrolyte according to claim 19, wherein Ar₁ of said hydrophobic segment shown in said chemical formula (3) is the chemical formula (6) and has a structural unit shown in said chemical formula (2).
